(19) United States
(12) Patent Application Publication
(10) Pub. No.: US 2021/0271050 A1
(43) Pub. Date: Sep. 2, 2021

(54) Focus and Zoom Objective and Method for Operating a Focus and Zoom Objective

(71) Applicant: QIOPTIQ PHOTONICS GMBH & CO. KG, Göttingen (DE)

(72) Inventors: Thomas Bodendorfer, Feldkirchen (DE); Andreeas Bollwein, Feldkirchen (DE)

(21) Appl. No.: 17/258,797

(22) PCT Filed: Sep. 27, 2018
(86) PCT No.: PCT/US2018/053054

§ 371 Date: Jan. 8, 2021

Related U.S. Application Data
(60) Provisional application No. 62/696,406, filed on Jul. 11, 2018.

(51) Int. Cl. G02B 7/09; G02B 7/02; G02B 15/14

(52) U.S. Cl. CPC G02B 7/09; G02B 15/143; G02B 7/021

(57) ABSTRACT

A zoom objective comprises housing lens, a first movable lens, and a first gearless motor. The first gearless motor is adapted to cause a first longitudinal movement of the first movable lens relative to the housing lens. A method of operating a zoom objective provides a first movable lens, a housing lens, and a first gearless motor. The method includes moving the first movable lens relative to the housing lens by a force generated by the first gearless motor.

### FIELD OF THE INVENTION

The present relates to a focus objective for an optical system and a method for operating an objective.

### BACKGROUND OF THE INVENTION

Presently, focus objective devices may allow for quickly changing a focus or zoom setting and providing high resolution, and high sharpness. However, such devices generally fail to provide quick, precise changes of a focus/zoom. For example, a piezo objective translation mechanism (such as a ceramic piezoelectric stack actuator or linear piezo motor) typically provides a lens translation range on the order of only few nm to 0.5 cm. As another example, spindle motor and gear translation means may lack the precision to quickly and repeatedly return an optical element to a desired location. In general, linear motors are costly and overly large for many optical applications. Therefore, there is a need for a focus/zoom objective providing improved speed, range, accuracy and reliability.

### SUMMARY OF THE INVENTION

According to an embodiment of the invention a zoom objective includes a housing lens, a first movable lens, and a first gearless motor, for example, a disc motor, wherein the first gearless motor is adapted to cause a first longitudinal movement of the first movable lens relative to the housing lens.

According to an embodiment of the invention a method of operating a zoom objective provides a first movable lens, a housing lens, and a first gearless motor, wherein the method further includes moving the first movable lens relative to the housing lens by a force generated by the first gearless motor.

An exemplary embodiment of a zoom objective includes a gearless motor exerting a rotational force for shifting a movable lens along a straight line and into a defined position within a zoom objective optical path. As a consequence, the position of the movable lens may generally be limited by the type of mechanical coupling of the gearless motor with the movable lens. The accuracy of the achievable position of the lens within the zoom objective may depend on the accuracy of positioning the motion system in conjunction with a sensor/scale position sensor. Further, the achievable accuracy of the position of the lens within the zoom may also depend on the type and sustainability of the mechanical coupling between the gearless motor and the movable lens, for example, by reducing the backlash, and increasing the stiffness. However, the rotational movement of the gearless motor may be adjusted according to the result of the sharpness of a picture delivered by the zoom objective. As a consequence, the rotational movement of the gearless motor may be controlled, for example, by a feedback loop. The movement of the movable lens may be corrected with respect to the feedback loop based on a sharpness of the zoom objective. A position of the movable lens may be measured using a scale and sensor located in the zoom objective.

According to an exemplary embodiment the zoom objective includes a first lens displacement unit, wherein the first lens displacement unit includes the first gearless motor, a first driving pulley, a first driven pulley, and a first thread spanning the first driving pulley and the first driven pulley. Further, the first movable lens may be coupled to the first thread so that a first rotational movement of the first gearless motor causes a turning of the first driving pulley and by this causing the first longitudinal movement of the first movable lens.

According to an exemplary embodiment the zoom objective further includes a first slide, and a first rail coupling to the first movable lens, so that the first longitudinal movement of the first movable lens is along an optical path.

According to an exemplary embodiment the zoom objective includes a second movable lens, and a second lens displacement unit including a second gearless motor, a second driving pulley, a second driven pulley, and a second thread spanning the second driving pulley and the second driven pulley, wherein the second movable lens is coupled to the second thread so that a second rotational movement of the second gearless motor causes a turning of the second driving pulley and by this causing a second longitudinal movement of the second movable lens.

The first and the second gearless motor may work independently so that the first and second lens are independently movable. In particular, a desired sharpness of the zoom device may depend upon the feedback loops of the first and/or the second movable lens.

According to an exemplary embodiment the zoom objective includes a central controller controlling the first gearless motor, and the second gearless motor, so that the first longitudinal movement of the first movable lens and the second longitudinal movement of the second movable lens are collision-free.

A controller, in particular the central controller, may control one or more gearless motors to position one or more lens groups moved by the one or more gearless motors based on a database defining allowed non-colliding positions of the one or more gearless motors. And further, the controller may correct the rotational movement of one or more gearless motors, for example, with respect to a feedback loop based on a desired sharpness of the zoom objective. The controller may receive a desired zoom magnification as a first input, for example but not limited to 0.5× to 10×. The controller may receive as a second input sensor information indicating the position of one or more of the movable lenses. The controller makes use of a database of positions of the one or more movable lenses measured by a scale within the zoom objective to send corrected data to the gearless motor for adjusting the position of the one or more movable lenses.

According to an exemplary embodiment the zoom objective includes a third movable lens and a third lens displacement unit including a third gearless motor, a third driving pulley, a third driven pulley, and a third thread, spanned between the third driving pulley and the third driven pulley, wherein the third movable lens is coupled to the third thread so that a third rotational movement of the third gearless motor causes a turning of the third driving pulley and by this causing a third longitudinal movement of the third movable lens.

The first, the second, and the third gearless motor may work independently so that the first and second lens are movable independently from each other, or alternatively, the movement of two or more of the lenses may be co-dependent. Accordingly, the controller may control the movement of the first, second, and third gearless motor based on a database defining allowed non-colliding positions of the first, second, and third gearless motor. Further, the controller may correct the rotational movement of the first, second, and third gearless motor with respect to a feedback loop based on a desired and detected sharpness of an image produce by the zoom objective. The feedback loop may include a database of positions of the first, second, and/or third movable lenses measured by a scale within the zoom objective to send corrected data to the gearless motor for adjusting the position of the first, second, and/or the third movable lens.

According to an exemplary embodiment, a zoom device includes the zoom objective, one or more slides, and a rail adapted for guiding a movement of the zoom objective along the optical path. In particular, the one or more slides and the rail may be fixed to a housing containing the movable lenses. The one or more slides and/or the rail are preferably configured to sense a position of the one or more slides with respect to the rail, for example using a scale incorporated into the one or more slides and/or the rail.

According to an exemplary embodiment a zoom device has a zoom objective having, a housing lens, a first movable lens, and a first gearless motor, wherein the first gearless motor is adapted to move the first movable lens relative to the housing lens, and along an optical path; and the optical zoom device further having, a slide, and a rail, wherein the optical zoom objective is mounted to at least one of the slide, or the rail, so that the optical zoom objective is movable parallel to the optical path. As set forth above, the zoom objective may have more than three movable lenses.

According to an exemplary embodiment a method of operating the zoom objective provides a first lens displacement unit, wherein the first lens displacement unit has a first gearless motor, a first driving pulley, a first driven pulley, and a first thread spanned between the first driving pulley and the first driven pulley. The first movable lens may be coupled to the first thread, and the method may further include rotating the first gearless motor which causes a turning of the first driving pulley, and by this causes a first longitudinal movement of the first movable lens.

According to an exemplary embodiment the method of operating the zoom objective further provides a second movable lens, and a second lens displacement unit including a second gearless motor, a second driving pulley, a second driven pulley, and a second thread, spanned between the second driving pulley and the second driven pulley. The second movable lens may be coupled to the second thread, and the method may further include rotating the second gearless motor which causes a turning of the second driving pulley, and by this causes a second longitudinal movement of the second movable lens.

According to an exemplary embodiment the method of operating the zoom objective further provides a central controller, wherein the method may further include controlling the first gearless motor, and the second gearless motor, by the central controller so that the first longitudinal movement of the first movable lens, and the second longitudinal movement of the second movable lens are collision-free.

According to an exemplary embodiment the method of operating the zoom objective provides a third movable lens, and a third lens displacement unit having a third gearless motor, a third driving pulley, a third driven pulley, and a third thread, spanned between the third driving pulley and the third driven pulley. The third movable lens may be coupled to the third thread, and the method may further include rotating the third gearless motor which causes a turning of the third driving pulley causing a third longitudinal movement of the third movable lens.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 shows an exploded perspective view of an exemplary embodiment of a zoom device.

FIG. 2 shows a perspective view of the zoom objective of FIG. 1 including two gearless motors.

FIG. 3 shows a schematic depiction of the lens displacement unit of FIG. 2.

FIG. 4 is a schematic diagram of an exemplary embodiment of a zoom device having four lenses.

FIG. 5 is a schematic diagram illustrating an example of a system for executing functionality of the present invention.

FIG. 6 shows a flowchart of an exemplary method for operating the zoom device of FIG. 1.

FIG. 7A is a schematic drawing of a zoom device with three lenses and transports from a top view perspective.

FIG. 7B shows the zoom device of FIG. 7A from a side view perspective.

FIG. 8 is a schematic drawing of a zoom device with an alternative arrangement of three lenses and transports from a side view perspective.

### DETAILED DESCRIPTION

The following definitions are useful for interpreting terms applied to features of the embodiments disclosed herein, and are meant only to define elements within the disclosure.

As used herein, the expression “zoom objective” or “optical objective” generally refers to a device for focusing a device with an optical path, for example, a camera or microscope on an object using a set of lenses so that for example the object's apparent distance from the observer changes. The zoom objective may operate upon, for example, but not limited to, visible light. Other applications for a zoom objective may include, for example, a lens system for focusing

As used herein, the term “lens” generally refers to a simple piece of transparent material (such as glass for visible light) that has two opposite regular surfaces either both curved or one curved and the other plane and that is used either singly or combined in an optical instrument, such as the zoom objective, for forming an image by focusing electromagnetic rays, for example, rays of light. There may be different types of lenses included such as concave, or convex lenses, or the like. A combination of two or more simple lenses may build up the zoom objective.

As used herein, the expression “housing lens” generally refers to a lens which is stationary within the zoom objective, or within a housing of the zoom objective. The housing lens is generally fixed with respect to a housing for the zoom objective, although alternative embodiments the housing lens may be fixed with respect to a reference other than the housing.

As used herein, the expression “movable lens” generally refers to a lens being a mobile part or sliding part within the housing of the zoom objective. A movable lens is movable with reference to the housing lens and/or the object. There is at least one movable lens within the zoom objective. By shifting the movable lens (or lenses) within the zoom objective desired properties of the zoom objective are achieved. While each movable lens is generally referred to herein as a single lens, each movable lens may be composed of a group of lenses.

As used herein, the expression “gearless motor” generally refers to a gearless electrical device exerting a torque on an axis, for example 20 mNM, +/−5 mNM. Compared with a motor incorporating gears, a gearless drive may both reduce wear and improve controllability of the motion system due to decreased backlash and improved stiffness. The gearless motor may include stationary parts and rotational parts such as a rotating disc. The gearless motor may be driven by electricity and may have a flat and circular shape. The gearless motor may be free of wearing parts such as brushes (referred to herein as a brushless gearless motor). Operation of the gearless motor, or brushless gearless motor may be electronically and/or manually controlled.

As used herein, the expression “longitudinal movement” generally refers to a change in position (displacement) of an object (for example, a lens or lens group) along a straight line path.

As used herein, the expression that the “movable lens moves relative to the housing lens” generally refers to a change in distance between the movable lens and the housing, for example, due to a longitudinal movement of the movable lens, or lenses.

As used herein, the expression that the gearless motor is “adapted to cause a movement” indicates that a torque exerted by the gearless motor may be transmitted into a force causing a longitudinal displacement of one or more movable lenses. The expression “a force generated by” may likewise denote that the gearless motor causes the movable lens to actually move longitudinally.

As used herein, the expression “lens displacement unit” may generally denote an assembly of parts including speed-changing gears and the driveshaft by which power is transmitted from a motor, here the brushless gearless motor, to a linearly movable part, here the movable lens.

As used herein, the expression “driving pulley” generally refers to a wheel being directly coupled to the gearless motor so as to transmit the power of the gearless motor. A non-flexible thread (or band, belt, rope, or chain, among other possibilities) may pass over the rim of the pulley. Here, non-flexible generally indicates that the portion of the thread passing between the driving pulley and the driven pulley is sufficiently rigid that a lens connected to the thread, for example by a clamped or crimped block of metal, may be precisely positioned without significant play or variation, for example, a variation less than +/−1 micron over a range on the order of 1-15 cm, or having a Young's modulus in the range of, for example, but not limited to 50 GPa-150 GPa.

As used herein, the expression “driven pulley” generally refers to a wheel which may indirectly be driven by the driving pulley. For this, the non-flexible thread, or the like may extend between the driving pulley and the driven pulley.

As used herein, the expression “thread spanned between” generally refers to that the non-flexible thread may engage with the rim of the driving pulley, engage with on the rim of the driven pulley, and transmit the power from the gearless motor to the thread, to the driven pulley and finally also to the movable lens.

As used herein, the expression that “the movable lens is coupled to the thread” generally refers to that the movable lens is fixed to the thread so that a rotation of the gearless motor is directly transmitted to the longitudinal movement of the movable lens. The movable lens may be fixed to the thread where the thread extends linearly between the driving pulley and the driven pulley.

As used herein, the expressions “slide” and “rail” generally refers to a device allowing for a guided movement of a mechanical part. As used herein, a lens or lens group may be mounted upon a slide configured to slide upon a rail so the lens and slide may move longitudinally along the rail, for example, along the optical path of the zoom objective. The slide and/or rail may be configured to sense the relative position of one or more slides upon the rail and to convey data indicating the position of the one or more slides to an external controller.

As used herein, the expression “optical path” may define the way followed by a ray through an optical system, such as the zoom objective. It should be noted that “optical path” is not intended to limit the path to visible light, but may include visible and/or non-visible electromagnetic waves.

Reference will now be made in detail to embodiments of the present invention, examples of which are illustrated in the accompanying drawings. Wherever possible, the same reference numbers are used in the drawings and the description to refer to the same or like parts.

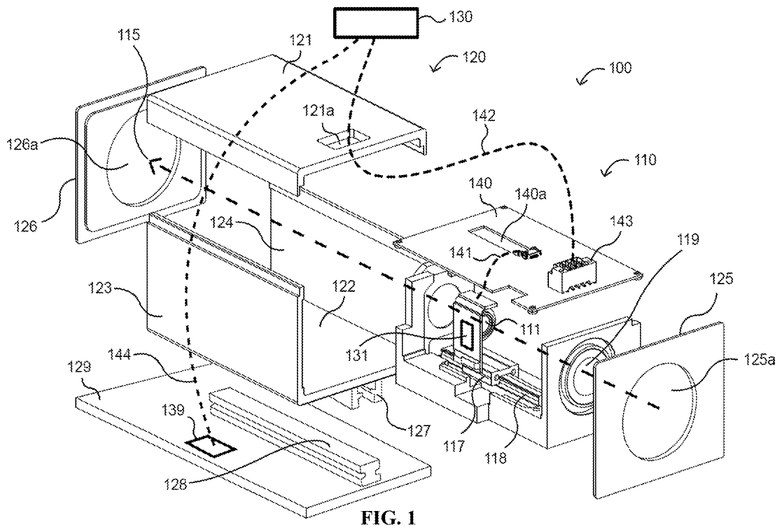

FIG. 1 shows a perspective and exploded view of an exemplary first embodiment of a zoom device 100 having a zoom objective 110 and a movable housing 120. While the first embodiment uses the terms “zoom device” and “zoom objective,” the use of the device is not limited to zoom functionality, and may provide additional optical functions, for example, focus and/or beam adjusting functions. The movable housing 120 accommodates the zoom objective 110. Further, the movable housing 120 may include a housing rail 128 and a housing slide 127 configured to move along the housing rail 128 to allow for movement of the movable housing 120 relative to a base plate 129 on which the housing rail 128 is fixed. The movable housing 120 has a first side plate 123, and a second side plate 124, both extending parallel to an optical path 115. The optical path 115 extends from an object to be examined (not shown) through a front plate 125 and via the zoom objective 110 through a back plate 126. The front plate 125, and the back plate 126 may, therefore, include a front plate opening 125a, and a back plate opening 126a, respectively to provide for passage of light through the movable housing 120 along the optical path. The movable housing 120 may further have a bottom plate 122 attached to the front plate 125 and the back plate 126 to which the housing slide 127 is fixed. As a consequence, the movable housing 120 may slide relative to the base plate 129 by shifting the housing slide 127 (mounted to the bottom plate 122), and the housing rail 128 (mounted to the base plate 129) relative to each other. Opposite the bottom plate 122, a top plate 121 is attached to the front plate 125 and the back plate 126 and located at the top side of the movable housing 120. While the first embodiment of the zoom device 100 has a substantially rectangular box shaped housing, alternative embodiments may have a different shaped housing.

The zoom objective 110 has a first movable lens 111. The first movable lens 111 is mounted on a first slide 117 interacting with a first rail 118 mounted directly or indirectly to the movable hosing 120. For example, the first rail 118 may be mounted on the bottom plate 122 of the movable hosing 120.

The zoom objective 110 further includes a housing lens 119 which may be directly or indirectly mounted to the movable housing 120, for example, mounted to the front plate 125 of the movable housing 120. The optical path 115 extends within the zoom objective 110 from the examined object through the housing lens 119, and further through the first movable lens 111 towards a sensor (not shown), for example, an image sensor or another image collector or image viewer.

The optical path 115, the first slide 117, and the first rail 118 couple to the first movable lens 111, the housing slide 127, and the housing rail 128 couple to the housing lens 119, all extend parallel to each other. Hence, the first movable lens 111 moves parallel to the optical path 115. This provides a precise positioning relative to the examined object for both the housing lens 119 and the first movable lens 111, and to each other with a high degree of accuracy according to an optical inspection.

The zoom device 100 includes electronic circuitry including one or more controllers 130, 131, 139. A wiring board 140 has a board socket 143 configured to receive electronic circuitry that may be located beneath the top plate 121. The wiring board 140 may be electrically coupled to a first movable controller 131 mounted upon the first slide 117. The wiring board 140 may be coupled to the first movable controller 131, for example by a first flexible wire 141 passing through an opening 140a.

The first movable controller 131 may receive sensor data regarding a position of the first slide 117 with respect to the first rail 118 and provide the sensor data to the wiring board 140. From there, the data are further submitted to a central controller 130, for example, by a second flexible wire 142 which connects to the board socket 143 located on the wiring board 140. The top plate 121 of the movable housing 120 may have a top opening 121a enabling the second flexible wire 142 to extend through the top plate 121.

A stationary controller 139 is located on the base plate 129 and may be coupled to the central controller 130. The housing slide 127 may include a sensor and/or a scale for detecting the position of the housing slide 127 relative to the housing rail 128. The stationary controller 139 may transmit data captured from a position of the housing slide 127 to the central controller 130. Data coming from the stationary controller 139 and from the first movable controller 131 may be analyzed by the central controller 130. The central controller 130 may send control commands to the stationary controller 139 in order to control the position of the first lens 111.

While the first embodiment includes multiple controllers 131, 130, 139, alternative embodiments may have decentralized controller, and/or fewer controllers, or a single controller configured to track and/or control movements of the movable components, for example, slides 117, 127 and rails 118, 128. For purposes of clarity, FIG. 1 only shows a first slide 117, a first movable controller 131, and a first movable lens 111, although embodiments of the zoom device 100 may include motors and transports for moving one, two, three, or more movable lenses 111, 112, 113, where each movable lens 111, 112, 113, may have an associated movable controller 131.

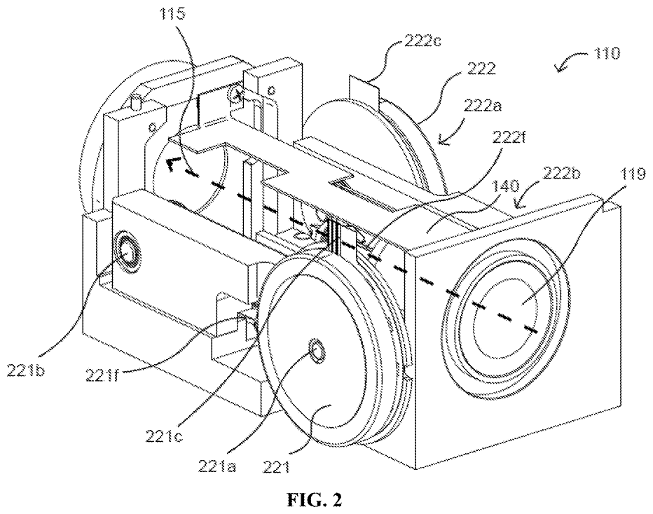

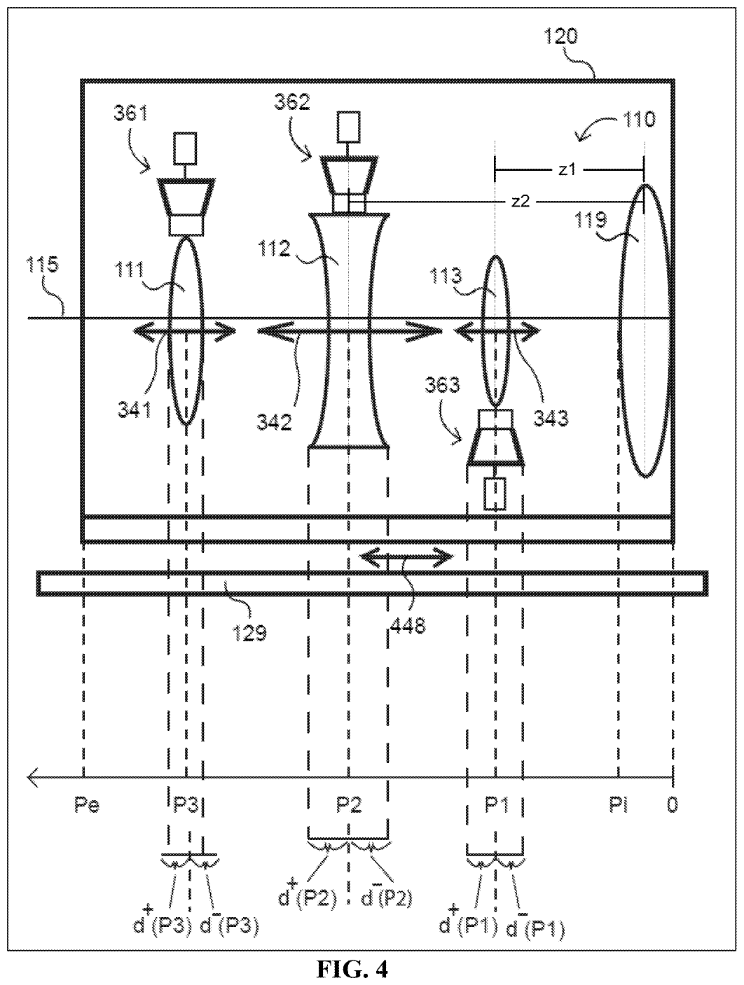

FIG. 2 shows a perspective view of the zoom objective 110 including a first gearless motor 221 and a second gearless motor 222. FIG. 2 illustrates that the first gearless motor 221 and the second gearless motor 222 are arranged on opposite sides of the optical path 115 behind the housing lens 119 (along the optical path 115 behind an object). Thus, an operating of the two gearless motors 221, 222 does not interrupt the optical path 115. In order to control a position of two moving lenses (not shown in FIG. 2; see FIG. 4, 111, 112, 113) simultaneously and independently the first gearless motor 221 has a first contact portion 321c, and the second gearless motor 222 has a second contact portion 322c. The first gearless motor 221 and the second gearless motor 222 may be stationary relative to the wiring board 140.

The first gearless motor 221 has a first driving pulley 221a and a first driven pulley 221b which mutually translate a rotational movement of the first gearless motor 221 into a longitudinal movement by means of a first thread 221f. Likewise, the second gearless motor 222 has a second driving pulley 222a and a second driven pulley 222b which mutually translate a rotational movement of the second gearless motor 222 into a longitudinal movement by means of a first thread 222f.

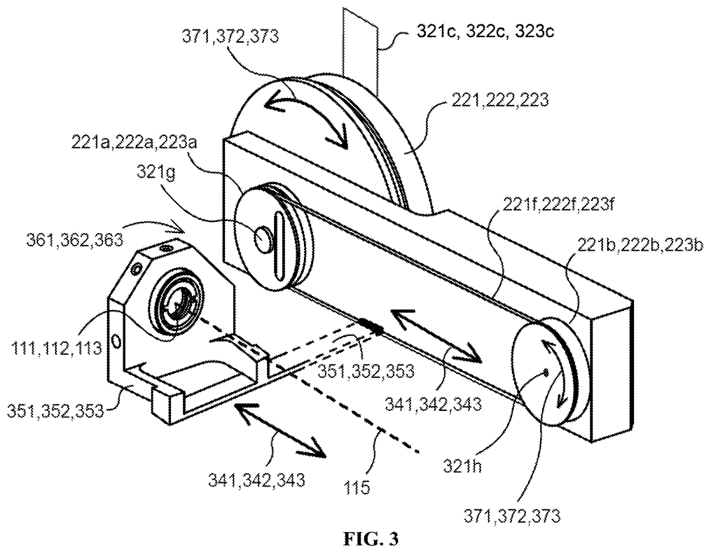

FIG. 3 shows a schematic depiction of a first lens displacement unit 361 coupled to a first movable lens 111 to allow for a first longitudinal movement range 341 of the first movable lens 111. The first lens displacement unit 361 includes a first gearless motor 221, a first driving pulley 221a, a first driven pulley 221b, a first thread 221f, and a first mechanical connection 351. The mechanical connection 351 couples the first thread 221f and the first movable lens 111.

Incoming control signals cause the gearless motor 221 to perform a rotary movement 371 in one or the opposite direction. The driving pulley 221a and the driven pulley 221b are coupled by the first thread 221f so that the rotary movement 371 of the gearless motor 221, and the driving pulley 221a, respectively, is translated into a longitudinal movement range 341 of the mechanical connection 351, and of the first movable lens 111. The longitudinal movement range 341 of the first movable lens 111 may be guided by first slide 117 (FIG. 1) on the first rail 118 (FIG. 1). A distance between a bearing 321g of the driving pulley 221a and a bearing 221h of the driven pulley 221b may thus limit the longitudinal movement range 341 of the first movable lens 111. For example, the distance may be on the order of 1-15 cm or more.

The mechanical connection 351 may have any size and may couple to the first thread 221f in any orientation so that a variety of mechanical connections 351 are possible. For example, the mechanical connection 351, 352, 353 may be a rigid block, such as aluminum, affixed to the thread 221f, 222f, 223f via crimping or clamping.

Similar to the first lens displacement unit 361 with the first gearless motor 221, the first driving pulley 221a, the first driven pulley 221b, the first thread 221f, and the first mechanical connection 351, there may be provided a second lens displacement unit 362, and a third lens displacement unit 363. Analogously, the second and third lens displacement units 362, 363 may include the second and third gearless motors 222, 223, second and third driving pulleys 222a, 223a, second and third driven pulleys 222b, 223b, second and third threads 222f, 223f, and second and third mechanical connection 352, 353.

However, even if the first, second, and third lens displacement units 361, 362, 363 have a similar structure (not making necessary to depict all of these) the first longitudinal movement 341 of the first movable lens 111, a second longitudinal movement 342 of a second movable lens 112, and a third longitudinal movement 343 of a third movable lens 113 may be independent from each other. This is because the central controller 130 may control rotary movements 371, 372, 373 of the first, second, and third gearless motors 221, 222, 223 respectively, independently of one another. It should be noted that the lens displacement units 361, 362, 363 may be made in a mirror image of the configuration shown in FIG. 3, for example, to accommodate mounting on opposite sides of the zoom objective 110, as shown in FIG. 2.

Each of the first movable lens 111, the second movable lens 112, and the third movable lens 113 may move independently of each other, limited by the position of the other lenses. The first movable lens 111 may be driven by a first lens displacement unit 361 and perform a movement over the first longitudinal movement range 341. Accordingly, the second movable lens 112, may be driven by a second lens displacement unit 362, as well as the third movable lens 113, may be driven by a third lens displacement unit 363. Thus, the first movable lens 111, the second movable lens 112, and the third movable lens 113 perform the first, second, and third longitudinal movement ranges 341, 342, 343, respectively. As outlined above, the first, second, and third lens displacement unit 361, 362, 363 couple in any orientation and size to the first, second, and third movable lenses 111, 112, 113, respectively, so that the three movable lenses 111, 112, 113 may be arranged mutually along the optical path 115. The zoom objective 110 may be arranged in the movable housing 120 to which the housing lens 119 is mounted. The housing lens 119 is also arranged along the optical path 115. The movable housing 120 may be moveably mounted on a base plate 129 so that a longitudinal housing movement 448 of the movable housing 120 causes an identical movement of the housing lens 119 along the optical path 115. Hence, the zoom objective 110 may vary its distance to an object (not shown) by the longitudinal housing movement 448. Further, the zoom objective 110 includes the three movable lenses 111, 112, 113 that may be independently movable in order to provide a variety lens spacing arrangements according to specific zoom requirements. The first, the second, and the third movable lenses 111, 112, 113 may each be of different types, for example, they may be converging lenses, a diffusion lenses, or any other lens type.

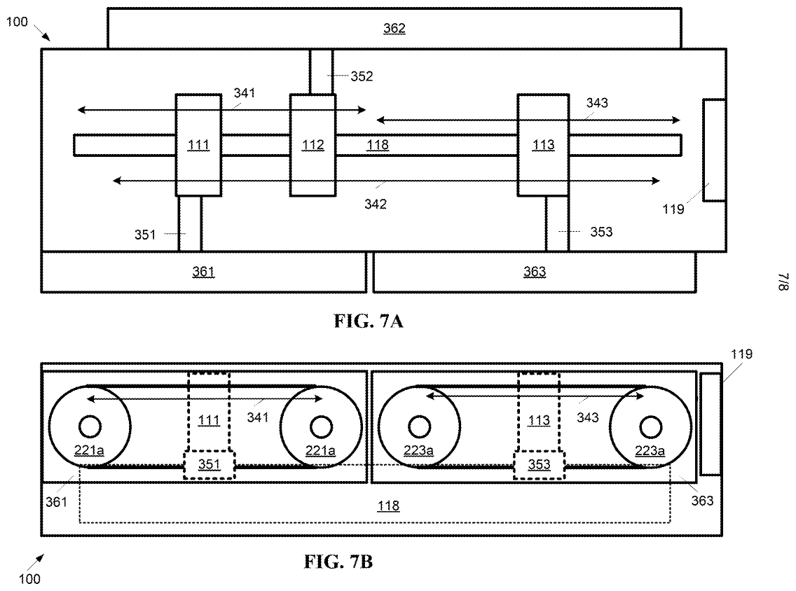

FIG. 7A shows a top view perspective of an implementation of the zoom device 100 depicting an exemplary first mounting arrangement of three lens displacement units 361, 362, 363. FIG. 7B shows a side view perspective of the exemplary first mounting arrangement of the first lens displacement unit 361 and the third lens displacement unit 363 of FIG. 7A.

The first lens displacement unit 361 and the third lens displacement unit 363 are mounted end-to-end on a first side of the zoom device 100 adjacent to the first side plate 123 (FIG. 1), and the second lens displacement unit 362 is mounted on a second side of the zoom device 100 adjacent to the second side plate 124 (FIG. 1). The first lens displacement unit 361 moves the first movable lens 111 longitudinally along the first rail 118 over a first longitudinal movement range 341. The second lens displacement unit 362 moves the second movable lens 112 longitudinally along the first rail 118 over a second longitudinal movement range 342. The third lens displacement unit 362 moves the third movable lens 113 longitudinally along the first rail 118 over a third longitudinal movement range 343.

Under the first mounting arrangement, shown in FIGS. 7A-7B, the first longitudinal movement range 341 does not overlap with the third longitudinal movement range 343, while the first longitudinal movement range 341 and the third longitudinal movement 343 do overlap with the second longitudinal movement range 342.

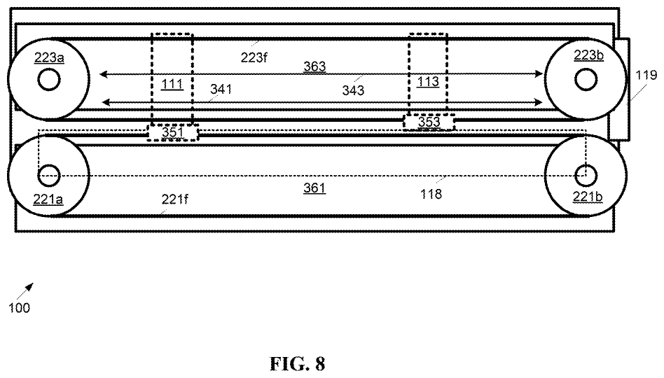

FIG. 8 shows a side view perspective of an exemplary second arrangement of the first lens displacement unit 361 and the second lens displacement unit 363 mounted to one side of the zoom device 100. As with FIG. 7A, the second lens displacement unit 362 is mounted on the opposite side of the zoom device 100 from the first lens displacement unit 361 and the second lens displacement unit 363.

The first lens displacement unit 361 and the third lens displacement unit 363 are mounted side-by-side on the zoom device 100 adjacent to the first side plate 123 (FIG. 1), and the second lens displacement unit 362 is mounted on the zoom device 100 adjacent to the second side plate 124 (FIG. 1). In contrast with the first mounting arrangement shown in FIGS. 7A, 7B, under the second mounting arrangement, shown in FIG. 8, the first longitudinal movement range 341 does overlap with the third longitudinal movement range 343. For example, the first mechanical connection 351 may be mounted on a top portion of the first thread 221f, and the third mechanical connection 353 may be mounted on a top portion of the third thread 223f The first longitudinal movement range 341 and the third longitudinal movement 343 each overlap with the second longitudinal movement range 342.

Other mounting arrangements of the lens displacement units 361, 362, 363 are also possible, for example, all of the lens displacement units may be mounted to the same side of the zoom device 100, and/or the movable lenses 111, 112, 113 may be mounted on the first rail 118 and/or mounted on a second rail (not shown) mounted side by side with or end-to-end with the first rail 118.

As shown by FIG. 4, the central controller 130 (FIG. 1) may control the position of the three movable lenses 111, 112, 112 according to the required zoom, for example, from 0.5× to 10× in any specific distance from the housing lens 119 to the object to be inspected. Additionally, the central controller 130 may have a table of allowed positions P1, P2, P3 of the three movable lenses 111, 112, 113 along the optical path 115 according to which the central controller 130 allows possible positions P1, P2, P3 which differ to at least the amount which is derivable by the thicknesses d⁺(P1, P2, P3), and d⁻(P1, P2, P3) of the three movable lenses 111, 112, 113, respectively. For example, the position P1 may define the position of the first movable lens 111 and d⁺(P1) may define the thickness of the first movable lens 111 in the direction towards the second movable lens 112. Further, the position P2 may define the position of the second movable lens 111 and d⁻(P2) may define the thickness of the second movable lens 112 in the direction towards the first lens 111. Then, by a given position P1 of the first movable lens 111 may result in a position P2 of the second movable lens 112 which is at least P1+d⁺(P1)+d⁻(P2). Same holds for an initial position P1 of the first movable lens 111 which is accordingly P1=d⁻(P1)+Pi where Pi defines a minimum position towards the housing lens 119. Analogously, an absolute end position Pe of the third movable lens 113 may be derived from an end position Pe where P3, the position of the third lens 113 is smaller than Pe+d⁺(P3).

Once the central controller 130 has obtained or otherwise determined the positioning of each of the three movable lenses 111, 112, 113, the central controller 130 may command the individual movable controllers 131 to move each of the three movable lenses 111, 112, 113 to the determined positions. The individual movable controllers 131 may move each of the three movable lenses 111, 112, 113 simultaneously, may move the each of the three movable lenses 111, 112, 113 one at a time, or may perform a sequence of movements where one, two, or three movable lenses 111, 112, 113 are moving at a particular moment in time. The central controller 130 may further be directed, for example, via a user interface (not shown), to individually adjust the position of one or more of the three movable lenses 111, 112, 113 in order to achieve a particular resulting image. The resulting position may then be saved, for example in a local or remote memory, so the central controller 130 may return the three movable lenses 111, 112, 113 to the saved positions.

Table 1 provides lens distances for three exemplary focus/zoom applications for the objective shown in FIG. 4. For Table 1, assume that lenses 111 and 119 are fixed, while lenses 112 and 113 are movable, z1 indicates a distance along the optical path 115 between midpoints of the lens 113 and lens 119, and z2 indicates a distance along the optical path 115 between the midpoints of the movable lens 112 and the housing lens 119.

TABLE 1

| Configuration | z1 | z2 |
|---|---|---|
| 1. (low magnification) | 4 mm | 34 mm |
| 2. (mid magnification) | 31 mm | 41 mm |
| 3. (high magnification) | 40 mm | 68 mm |

In the examples shown in Table 1, a position error on the order of as little as +/−5 μm may lead to a visible degradation of optical performance.

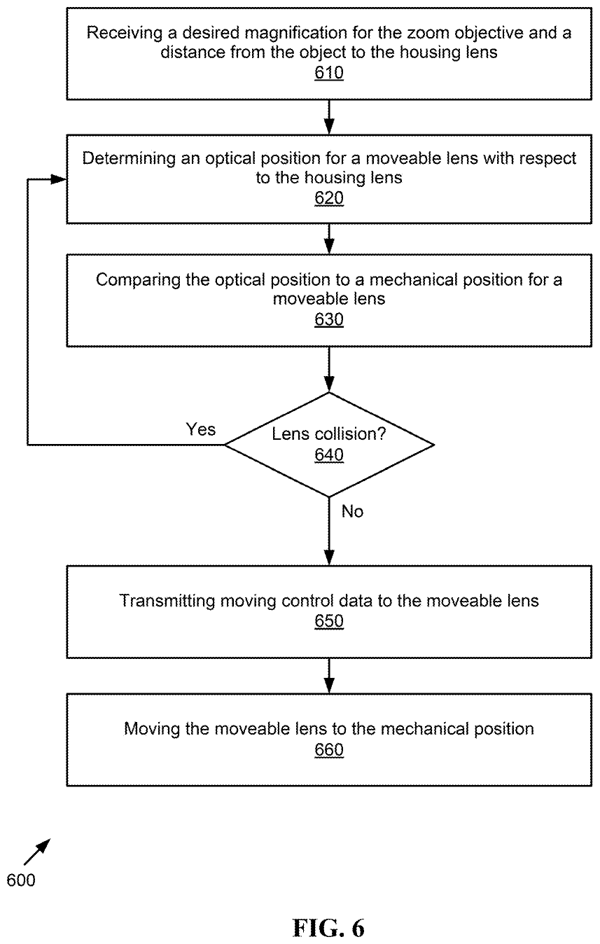

FIG. 6 is a flowchart of an exemplary method 600 for positioning independently movable lenses, described with reference to FIG. 4. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A desired zoom magnification for the zoom objective and a distance from the housing lens to the object is received, as shown by FIG. 610. For example, the central controller 630 may receive a zoom magnification from a user of the zoom objective 110 via a user interface.

An optical position P1, P2, P3 is determined for a movable lens 111, 112, 113 with respect to the housing lens 119, as shown by block 620. For example, the optical position P1, P2, P3 for the movable lens 111, 112, 113 may be calculated or fetched from a stored table according to specific optical requirements given by the distance of the housing lens 119 to the object and specific optical properties of all four lenses 111, 112, 113, 119. The optical position P1, P2, P3 is compared to a possible mechanical position for a movable lens 111, 112, 113, as shown by block 630.

If no potential collision of the movable lenses 111, 112, 113 is detected in the possible mechanical position P1, P2, P3, as shown by block 640, (the optical setup and the possible mechanical setup result in “no-collision”), then the central controller 130 sends moving control data towards the lens displacement units 361, 362, 363 for the movable lenses 111, 112, 113 as shown by block 650, which results in moving the three movable lenses 111, 112, 113 to the mechanical position P1, P2, P3, as shown by block 660.

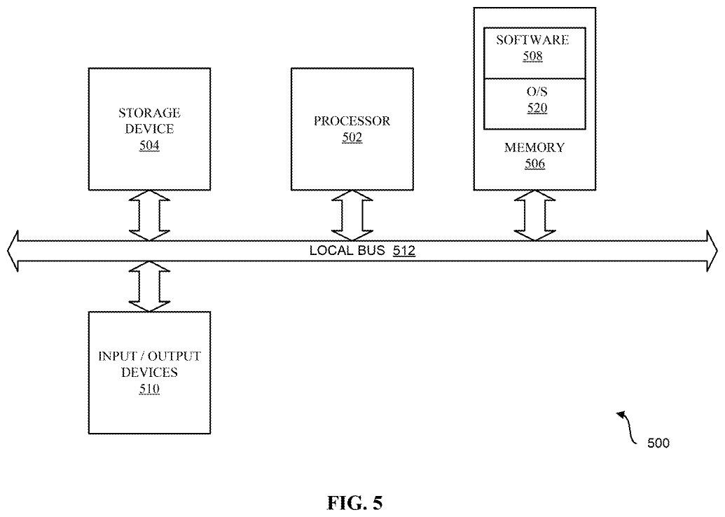

The present system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

We claim:

1. An optical objective (110) comprising:
a housing;
a housing lens (119) fixed relative to the housing and arranged in an optical path (115),
a first movable lens (111) disposed within the housing and arranged in the optical path,
and a first gearless motor (221) in mechanical communication with the first movable lens, wherein
the first gearless motor is adapted to cause a first longitudinal movement (341) of the first movable lens relative to the housing lens along the optical path.

2. The optical objective of claim 1, wherein the first longitudinal movement is in the range of 1 to 15 cm.

3. The optical objective of claim 1, wherein the first movable lens and or the housing lens comprises a group of lenses.

4. The optical objective of claim 1, further comprising:
a first displacement unit (361) comprising the first gearless motor, a first driving pulley (221a) in rigid rotational communication with the first gearless motor, a first driven pulley (221b), a first thread (321f) spanned between the first driving pulley and the first driven pulley, and a coupling between the first movable lens and the first thread, wherein a first rotational movement of the first gearless motor rotates the first driving pulley causing the first longitudinal movement of the first movable lens in the optical path.

5. The optical objective of claim 4, further comprising:
a first slide (117) affixed to the housing, and a first rail (118) coupling to the first movable lens, configured to guide the first movable lens on the first longitudinal movement.

6. The optical objective of claim 5, further comprising:
a second movable lens (112) disposed within the housing and arranged in the optical path, and a second lens displacement unit (362) comprising a second gearless motor (222), a second driving pulley (222a), a second driven pulley (222b), a second thread (222f), spanning the second driving pulley and the second driven pulley, and a coupling between the second movable lens and the second thread, wherein a second rotational movement (372) of the second gearless motor rotates the second driving pulley causing a second longitudinal movement (342) of the second movable lens in the optical path.

7. The optical objective of claim 6, further comprising:
a controller (130) comprising a memory and a processor configured to control one or more of the first gearless motor and the second gearless motor, so that the first longitudinal movement of the first movable lens, and the second longitudinal movement of the second movable lens are collision-free.

8. The optical objective of claim 7, wherein the controller is configured to control the first gearless motor to move the first movable lens to a predetermined first position and/or control the second gearless motor to move the second movable lens to a predetermined second position.

9. The optical objective of claim 7, further comprising:
a third movable lens (113), and a third lens displacement unit (363) comprising a third gearless motor (223), a third driving pulley (223a), a third driven pulley (223b), a third thread (223f), spanning the third driving pulley and the third driven pulley, and a coupling between the third movable lens and the third thread 223f, wherein a third rotational movement (373) of the third gearless motor rotates the third driving pulley, causing a third longitudinal movement (343) of the third movable lens in the optical path.

10. The optical objective of claim 4, wherein the first gearless motor is adapted to cause the first longitudinal movement (341) of the first movable lens relative to the housing lens along the optical path at a rate of at least 5 cm per second with a precision of plus or minus 1 micron or better, and/or the first thread has a Young's modulus in the range of 50 GPa to 150 GPa.

11. The optical objective according to claim 1, further comprising a slide (127) and a rail (128) adapted to guide a movement of the zoom objective along the optical path.

12. A method of operating an optical objective (110), comprising a first movable lens (111), a housing lens (119), and a first gearless motor (221), the method comprising the step of:
moving the first movable lens relative to the housing lens by a force generated by the first gearless motor.

13. The method of claim 12, further comprising a first lens displacement unit (361), the first lens displacement unit (361) comprising the first gearless motor (221), a first driving pulley (221a), a first driven pulley (221b), and a first thread (221f) spanning the first driving pulley and the first driven pulley, the first movable lens coupled to the first thread, wherein the method further comprises the step of:
rotating the first gearless motor which causes a turning of the first driving pulley, and a first longitudinal movement (341) of the first movable lens.

14. The method of claim 13, further comprising a second movable lens (112), and a second lens displacement unit (362) comprising a second gearless motor (222), a second driving pulley (222a), a second driven pulley (222b), and a second thread (222f) spanning the second driving pulley and the second driven pulley, wherein the second movable lens is coupled to the second thread, wherein the method comprises the step of:
rotating the second gearless motor causing a turning of the second driving pulley, and by this causing a second longitudinal movement (342) of the second movable lens.

15. The method of claim 14, further comprising a controller (130), wherein the method further comprises the step of:
controlling the first gearless motor, and/or the second gearless motor, by the controller so that the first longitudinal movement of the first movable lens, and the second longitudinal movement of the second movable lens are collision-free.

16. The method of claim 15, further comprising a third movable lens (113), and a third lens displacement unit (363) comprising a third gearless motor (223), a third driving pulley (223a), a third driven pulley (223b), and a third thread (223f) spanning the third driving pulley and the third driven pulley, wherein the third movable lens (113) is coupled to the third thread, wherein the method further comprises the step of:
rotating the third gearless motor, causing a turning of the third driving pulley, and causing a third longitudinal movement (343) of the third movable lens.
